(19) United States
(12) Patent Application Publication
(10) Pub. No.: US 2008/0265072 A1
(43) Pub. Date: Oct. 30, 2008

(54) Cutting Blade and Rotary Cutting Assembly for Shredders

(76) Inventor: Tie Chun WANG, Taipei (TW)

Correspondence Address: Venable, 2049 Century Park East, 21st Floor, LOS ANGELES, CA, 90067, US

(21) Appl. No.: 12/170,266

(22) Filed: Jul. 9, 2008

Related U.S. Application Data
(63) Continuation-in-part of application No. 11/602,133, filed on Nov. 20, 2006.
Application No. 11/602,133 is a continuation-in-part of application No. 11/809,954, filed on Jun. 4, 2007.
Application No. 11/809,954 is a continuation-in-part of application No. 11/296,399, filed on Dec. 8, 2005, now Pat. No. 7,354,012.
Application No. 11/296,399 is a continuation-in-part of application No. 10/721,422, filed on Nov. 26, 2003, now Pat. No. 7,044,410.

(51) Int. Cl. B02C 18/18; B26D 1/12

(52) U.S. Cl. 241/220; 83/676

(57) ABSTRACT

The present invention relates generally to cutting blades for shredders. Specifically, this invention teaches cutting blades, cutting blade assemblies, and a rotary cutting assembly which reduce the power needed to shred paper, plastic, and other forms of media that hold information. This is accomplished by creating a cutting blade with at least three adjacent teeth. The formation of three or more adjacent teeth more readily tears through paper and other media thus reducing the amount of power necessary to drive a shredder. This invention further discloses light weight cutting blades which require less material to manufacture, thus saving both materials and cost.

### CROSS-REFERENCE TO PRIOR APPLICATIONS

This application is a continuation-in-part application of U.S. patent application Ser. No. 11/602,133, filed on Nov. 20, 2006. This application is also a continuation-in-part application to U.S. patent application Ser. No. 11/809,954, filed on Jun. 4, 2007, which is a continuation-in-part application to U.S. patent application Ser. No. 11/296,399, filed on Dec. 8, 2005, which is a continuation-in-part application of U.S. patent application Ser. No. 10/721,422, filed on Nov. 26, 2003, now U.S. Pat. No. 7,044,410, the entire contents of which are all incorporated herein by reference.

### BACKGROUND OF THE INVENTION

1. Area of the Art

The present invention relates generally to cutting blades for shredders. Specifically, this invention teaches cutting blades and a rotary cutting assembly which reduce the power needed to shred paper, plastic, and other forms of media that hold information. This invention further discloses light weight cutting blades which require less material to manufacture, thus saving both materials and cost.

2. Description of the Background Art

With increased privacy concerns, shredders have become an integral part in both homes and businesses. Though originally used to destroy paper products, shredders are now used to shred other forms of media that hold information, such as compact discs. In addition, credit cards and other plastic products are commonly shredded.

Conventional shredders use a plurality of cutting blades spaced apart along a rotary shaft to form a rotary cutting assembly. Articles are shredded when fed through two parallel and opposite rotating rotary cutting assemblies.

The first common conventional shredder, called the strip-cut shredder, cut paper into strips along the entire length of the paper. A drawback with this type of shredder is that the strips can be pieced together like a puzzle.

In order to decrease this likelihood, shredder manufacturers developed the cross-cut shredder which shreds paper into tiny rectangles. This is accomplished by again having two parallel and opposite rotating rotary cutting assemblies. Cutting blades are again spaced apart along the length of each rotary shaft. When paper is fed through the two rotary cutting assemblies, it is cut in a similar fashion as the strip cut shredder. However, the cutting blades also have teeth protruding from each blade which puncture the strips into small rectangles, for example into 4 mm×40 mm pieces.

The teeth of each cutting blade are offset in the longitudinal direction of the rotary shaft such that they form a helix around the rotary shaft. The teeth are offset in order to decrease the amount of power needed to cut the paper. If the teeth were aligned in a row, then they would all punch the paper at the same time, thus requiring a more powerful motor to simultaneously punch through the paper.

The Diamond Cut shredder was the next innovation in shredders. Through the use of a unique and novel rotary cutting assembly utilizing round undulating blades, Diamond Cut shredders, are able to shred paper in a diamond shape, thus offering increased security.

Irrespective of the type of cut, a shredder may be generally categorized according to the maximum number of sheets that it can simultaneously shred. For example, a 10 sheet cross-cut shredder is designed to shred a maximum of 10 sheets. A 16 sheet cross-cut shredder is designed to shred a maximum of 16 sheets. Logically, the size of the shredder motor increases as the maximum number of sheets that the shredder can shred increases. More powerful motors are needed to shred greater amounts of paper, and are heavier and use more energy than the motors requiring less torque.

In order to save energy and reduce the size of the motor currently employed in shredders, the present invention seeks to employ various cutting blades and configurations which more readily shred paper thus reducing the size of the motor and saving energy.

One preferred embodiment of the claimed invention provides this by adding an additional cutting blade between the two cutting blades that are typically employed in a cross-cut shredder. The additional cutting blade has a spear shaped tooth which, in conjunction with two adjacent teeth, more readily tears through and shreds the paper.

Other preferred embodiments reduce the amount of material needed to manufacture a cutting blade. In one preferred embodiment, a cutting blade is punched from sheet metal having a thickness of about 0.3 mm. Typical cross-cut shredders are punched from 2 mm, so the savings in material is substantial. In order to prevent the cutting blade from flexing, the cutting blade has indentations in it. The cutting blade is also flanked on each side by supporting discs.

For smaller capacity shredders, two cutting blades punched from sheet metal having a thickness of about 0.3 mm may be placed together. In this embodiment, the supporting discs are not needed. The cutting blades have indentations which again help prevent the blades from flexing.

From the preceding descriptions, it is apparent that the devices currently being used have significant disadvantages and/or limitations. Thus, important aspects of the technology used in the field of invention remain amenable to useful refinement.

### SUMMARY OF THE INVENTION

The present invention relates to an apparatus that satisfies the need for a more efficient and power saving cutting blade incorporated into a rotary cutting assembly. In one preferred embodiment, an inner cutting blade having features of the present invention comprises a circular blade with at least two teeth that are spear shaped protruding from the blade. The inner cutting blade is then placed between two outer cutting blades with the same number of teeth, except the outer cutting blade teeth are flat and narrow. The blades are aligned such that the inner spear shaped tooth is sandwiched between the two outer, flat and narrow teeth. The blades are then spaced apart along the length of a rotary shaft and displaced along the longitudinal axis in order to form a helix around the rotary shaft. This novel rotary cutting assembly requires less power to shred. For instance, a 10 sheet shredder motor can now be used to shred 16 sheets.

In another preferred embodiment, an inner cutting blade is punched from sheet metal having a thickness of about 0.3 mm. The inner cutting blade has at least two tapered teeth which protrude from it. The inner cutting blade has indentations forming a hub and spokes in order to provide dimensional stability. In addition, two supporting discs flank the inner cutting blade for added support.

In another preferred embodiment, two cutting blades punched from sheet metal having a thickness of about 0.3 mm are placed together. Each cutting blade has indentations or ribs which provide stability and support.

All of the foregoing operational principles and advantages of the present invention will be more fully appreciated upon consideration of the following detailed description with reference to the drawings.

### DESCRIPTION OF THE FIGURES

The features and advantages of this invention are better understood with regard to the following drawings, description, and claims. The drawings consist of the following:

FIG. 1 is a perspective view of prior art cutting blades.

FIG. 2 is a planar view of prior art cutting blades.

FIG. 3 is a perspective view of a rotary cutting assembly embodying features of this invention.

FIG. 4 is an elevation side view of a rotary cutting assembly.

FIG. 5 is an elevation front view of a rotary cutting assembly.

FIG. 6 is an elevation front view of the rotary shaft.

FIG. 7 is an elevation side view of the rotary shaft.

FIG. 8 is a perspective view of a blade embodying features of this invention.

FIG. 9 is a side elevation view of a cutting blade embodying features of this invention.

FIG. 10 is a front elevation view of a cutting blade embodying features of this invention.

FIG. 11 is a perspective view of a cutting blade embodying features of this invention.

FIG. 12 is a side elevation view of a cutting blade embodying features of this invention.

FIG. 13 is a front elevation view of a cutting blade embodying features of this invention.

FIG. 14 is a perspective view of three cutting blades embodying features of this invention.

FIG. 15 is a side elevation view of a three cutting blades embodying features of this invention.

FIG. 16 is a perspective view of a partially assembled rotary cutting assembly.

FIG. 17 is a front elevation view of a partially assembled rotary cutting assembly.

FIG. 18 is a side elevation view of a partially assembled rotary cutting assembly.

FIG. 19 is a perspective view of two rotary cutting assemblies.

FIG. 20 is a side elevation view of two rotary cutting assemblies.

FIG. 21 is a perspective view of three cutting blades embodying features of this invention.

FIG. 22 is a side elevation view of three cutting blades embodying features of this invention.

FIG. 23 is a front elevation view of a cutting blade embodying features of this invention.

FIG. 24 is a perspective view of three cutting blades embodying features of this invention.

FIG. 25 is a side elevation view of three cutting blades embodying features of this invention.

FIG. 26 is a perspective view of a partially assembled rotary cutting assembly with paper strippers.

FIG. 27 is a front elevation view of a partially assembled rotary cutting assembly with paper strippers.

FIG. 28 is a side elevation view of a partially assembled rotary cutting assembly with paper strippers.

FIG. 29 is a perspective view of a partially assembled rotary cutting assembly with paper strippers.

FIG. 30 is a perspective view of a partially assembled rotary cutting assembly with paper strippers.

FIG. 31 is a perspective view of a rotary cutting assembly with paper strippers.

FIG. 32 is a front elevation view of a rotary cutting assembly with paper strippers.

FIG. 33 is a side elevation view of a rotary cutting assembly with paper strippers.

FIG. 34 is a perspective view of a cutting blade assembly.

FIG. 35 is a front elevation view of a cutting blade assembly.

FIG. 36 is a front elevation view of a cutting blade assembly.

FIG. 37 is a side elevation view of a cutting blade assembly.

FIG. 38 is a side elevation view of a cutting blade assembly.

FIG. 39 is a perspective view of a supporting disc.

FIG. 40 is a front elevation view of a supporting disc.

FIG. 41 is a side elevation view of a supporting disc.

FIG. 42 is a side elevation view of a supporting disc.

FIG. 43 is a perspective view of a cutting blade.

FIG. 44 is a front elevation view of a cutting blade.

FIG. 45 is a side elevation view of a cutting blade.

FIG. 46 is a side elevation view of a cutting blade.

FIG. 47 is a front elevation view of a supporting disc.

FIG. 48 is a side elevation view of a supporting disc.

FIG. 49 is a perspective view of a cutting blade assembly.

FIG. 50 is a front elevation view of a cutting blade assembly.

FIG. 51 is a side elevation view of a cutting blade assembly.

FIG. 52 is a side elevation view of a cutting blade assembly.

FIG. 53 is a perspective view of a cutting blade.

FIG. 54 is a front elevation view of a cutting blade.

FIG. 55 is a side elevation view of a cutting blade.

FIG. 56 is a side elevation view of a cutting blade.

FIG. 57 is a perspective view of a cutting blade.

FIG. 58 is a front elevation view of a cutting blade.

FIG. 59 is a side elevation view of a cutting blade.

FIG. 60 is a side elevation view of a cutting blade.

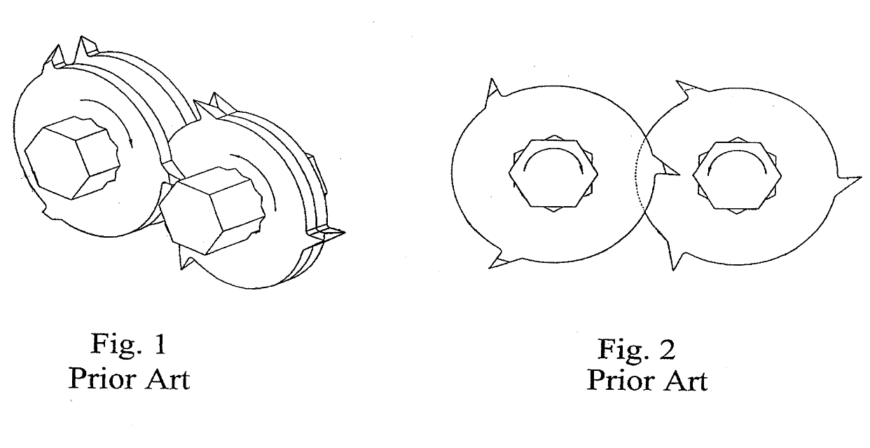

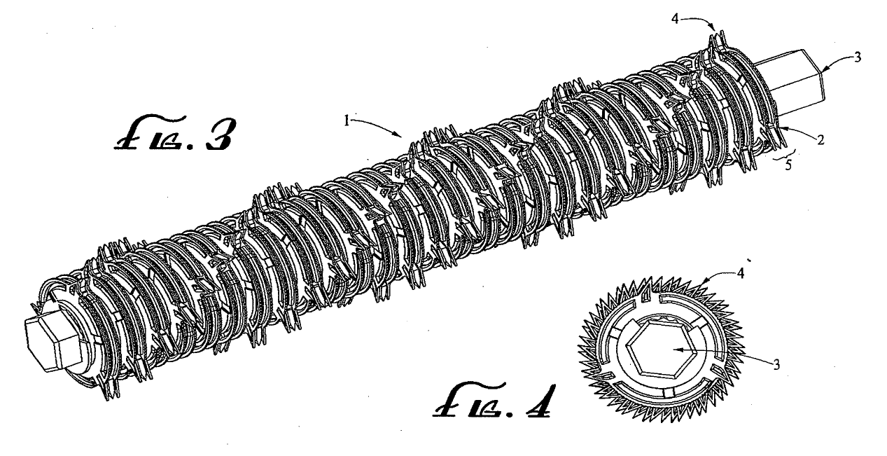

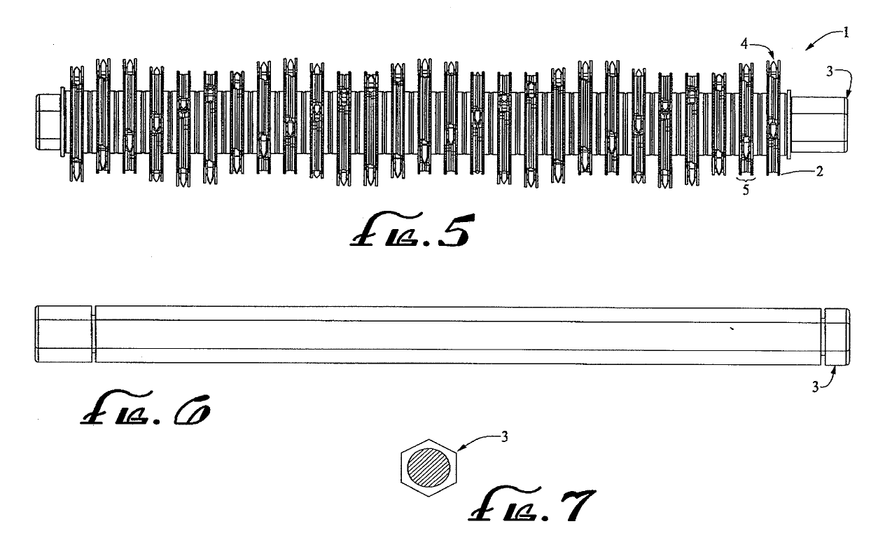

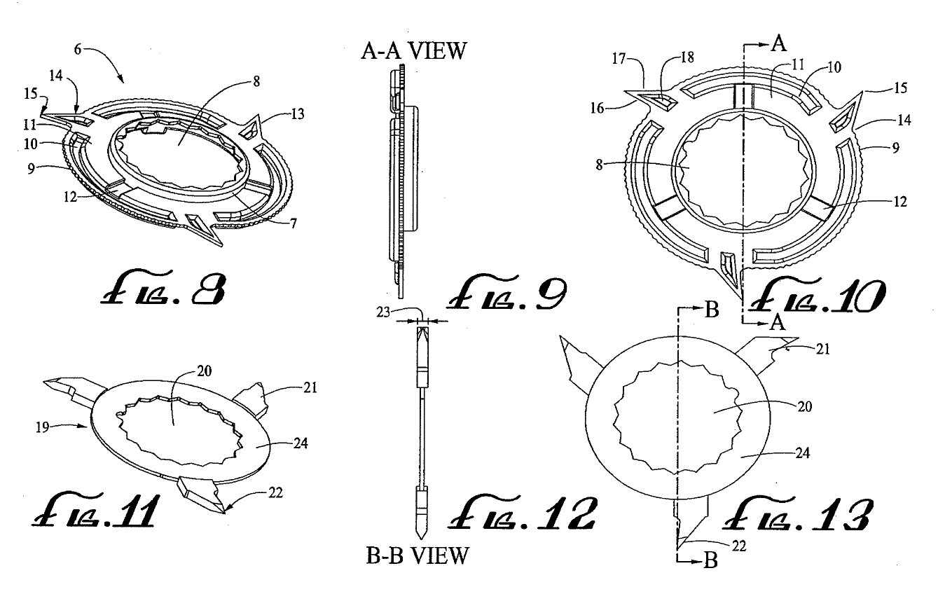

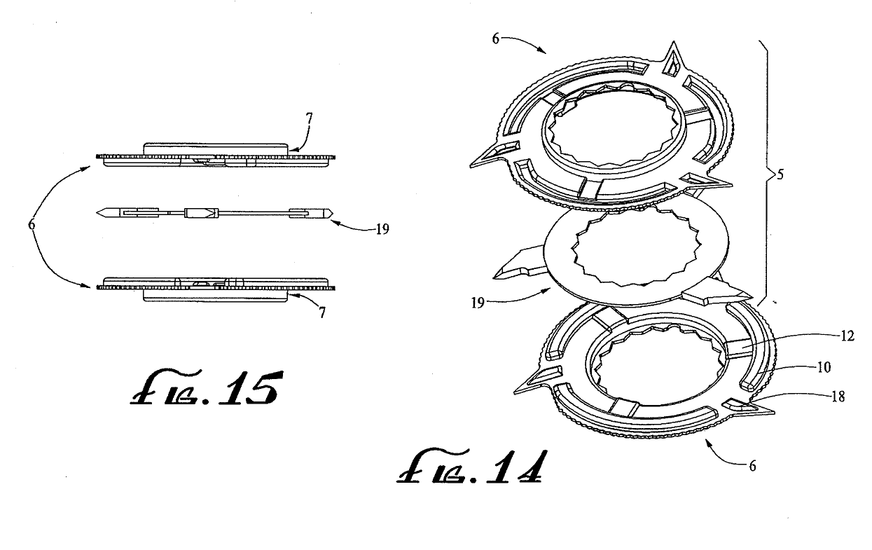

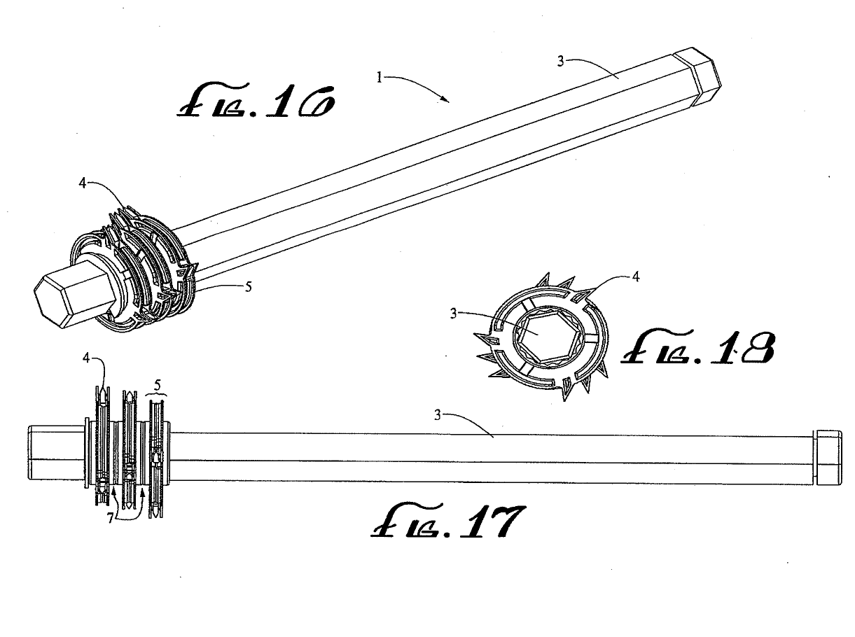

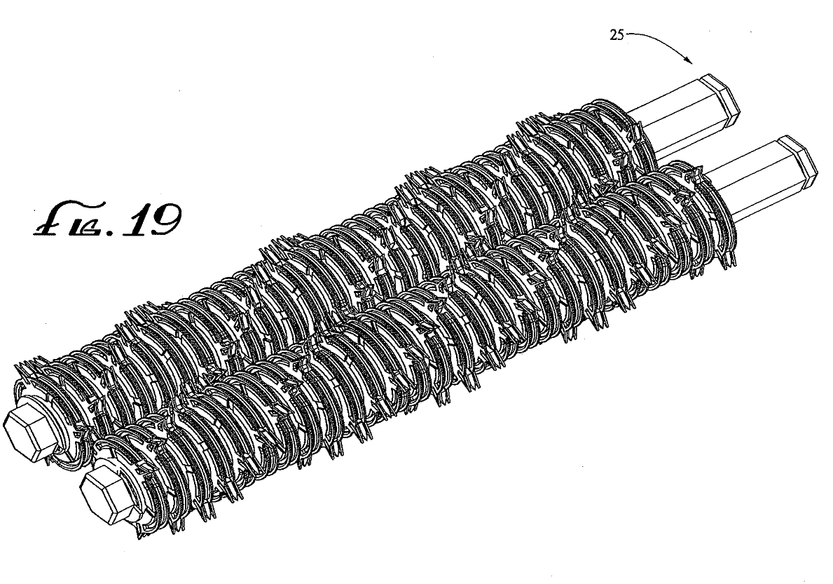

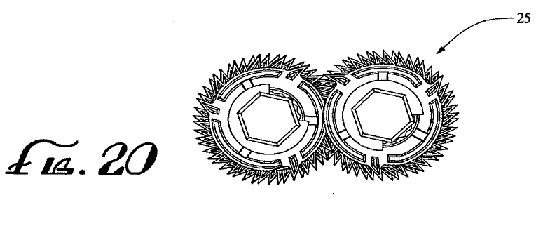

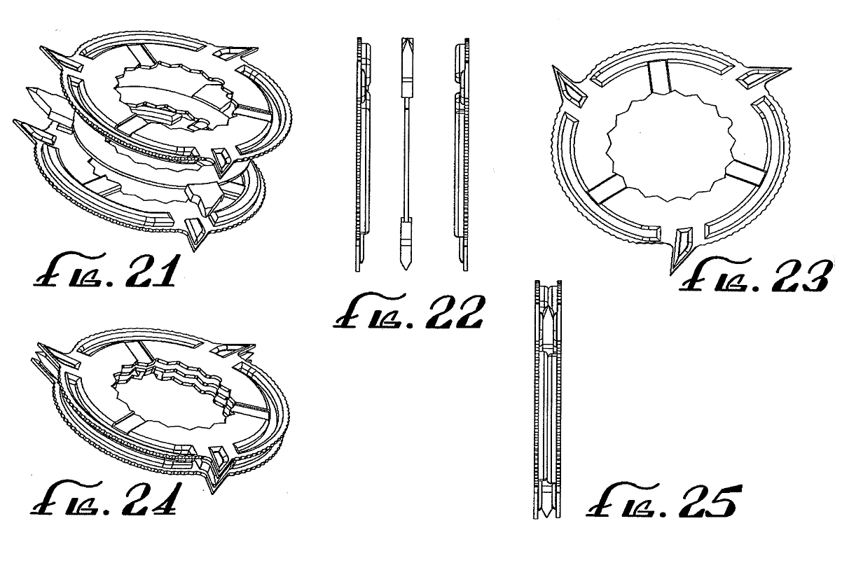

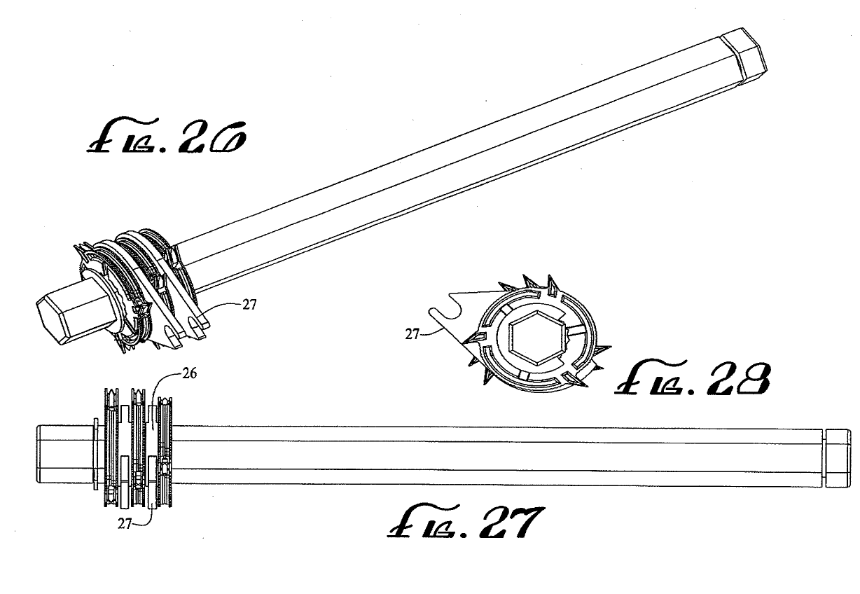

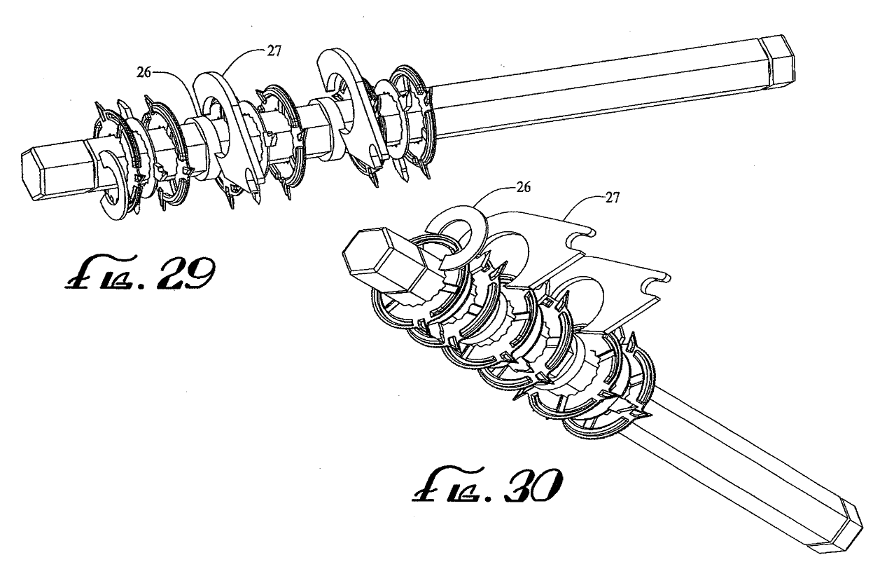

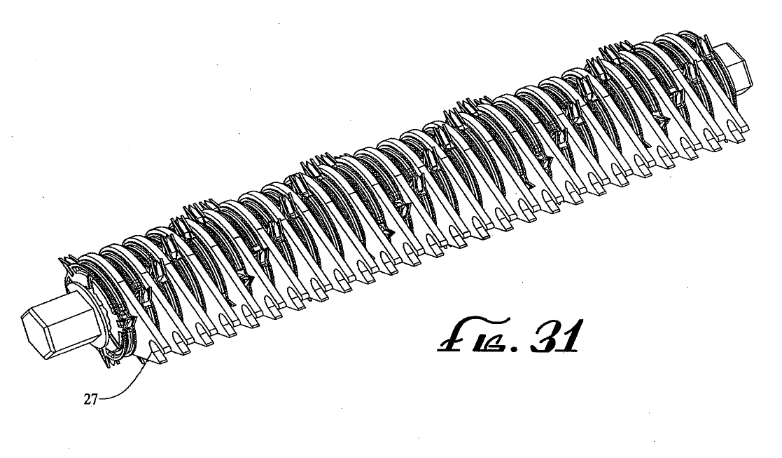

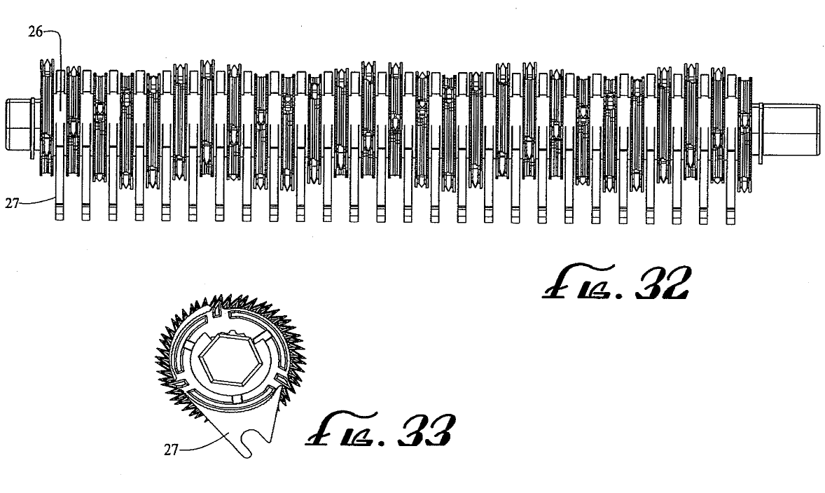

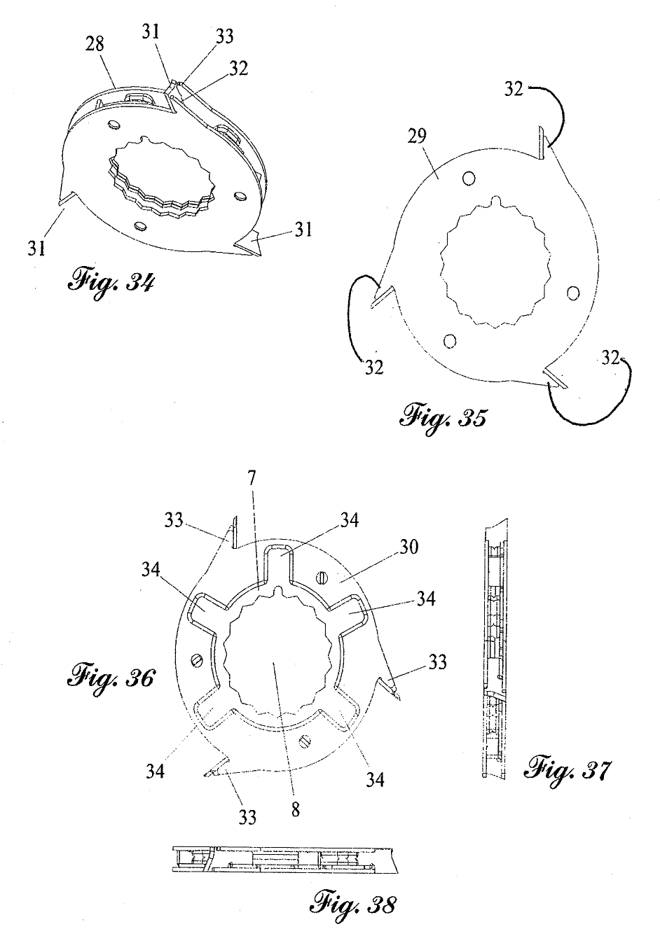

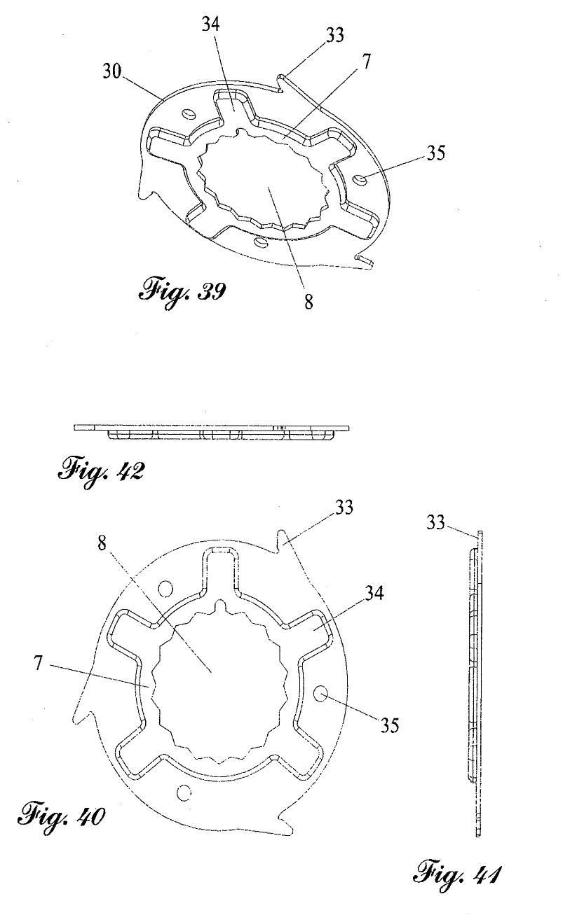

### DETAILED DESCRIPTION OF THE INVENTION

The following description is provided to enable any person skilled in the art to make and use the invention and sets forth the best modes contemplated by the inventor of carrying out his invention.

The essential elements of a shredder are comprised of a base, a housing, and a shredder mechanism which resides in the housing. The shredder mechanism contains two rotary cutting assemblies which shred paper as the paper is fed through the assemblies.

This invention discloses a rotary cutting assembly with a configuration that more efficiently shreds paper, thus requiring less power. The rotary cutting assembly is comprised of cutting blades spaced apart along the length of a rotary shaft. The cutting blade or blades are configured such that teeth protrude from it as described below.

FIGS. 3-20 disclose a first preferred embodiment of a rotary cutting assembly 1 with three cutting blades 2 forming a cutting blade assembly 5. As shown in FIGS. 3 and 5, the rotary cutting assembly 1 is comprised of cutting blade assemblies 5 spaced apart along the length of the rotary shaft 3. Each cutting blade assembly 5 has a plurality of teeth 4 that protrude from the cutting blades 2. As illustrated in FIGS. 6 and 7, the rotary shaft 3 is preferably hexagon in shape and made of a durable metal alloy such as steel.

In one preferred embodiment, the three cutting blades are coupled together to form a cutting blade assembly 5 (see FIG. 14) which assemblies are then spaced apart from other cutting blade assemblies 5 along the rotary shaft. FIGS. 8-10 illustrate the outer cutting blades 6 of the cutting blade assembly 5. An outer cutting blade 6 has a hub 7 with a polygonal hole 8 formed in the center of the hub 7 through which a rotary shaft 3 may pass. The polygonal shape locks into the polygonally (hexagonally) shaped rotary shaft thereby securing the cutting blade such that it will not rotate around the rotary shaft.

It is preferable that the periphery 9 of the outer cutting blade is serrated, though this is not necessary. The serration may serve to pull the paper to be cut through the rotary cutting assemblies. Towards the periphery of the outer cutting blade 6 is a plurality of indentations or ribs 10 in the body 11 of the cutting blade. The ribs 10 serve to reinforce the cutting blade and prevent it from flexing. In addition, the ribs 10 hold the inner cutting blade 19 in place. Substantially perpendicular to the ribs are additional indentations or spokes 12. The spokes 12 also serve as reinforcement for the cutting blade. In addition, the spokes 12 serve to support the inner cutting blade 19.

The outer cutting blades 6 also have three flat, narrow teeth 13 located 120 degrees apart around the circumference of the cutting blade. It should be appreciated that for larger capacity shredders which require larger cutting blades with a greater circumference, four teeth can be placed 90 degrees apart around the periphery. For shredders with smaller capacities and thus smaller cutting blades, two teeth can be placed 180 degrees apart around the periphery. The distance between the teeth determines the size of the shredded material. If there is less distance, the material is shredded into smaller pieces.

The outer cutting blade tooth 13 is preferably the same width as the cutting blade along the serrated periphery, and maintains the same width from the base 14 of the tooth to its tip 15. One side 16 of the outer cutting blade tooth is a few degrees from perpendicular to the tangent at the circumference of the cutting blade, while the other sloping side 17 is greater than 105 degrees from the tangent. The tooth is formed when the substantially perpendicular side 16 of the tooth and the sloping side 17 meet. The tooth also has an indented portion 18 which provides reinforcement in a similar manner that the ribs 10 and spokes 12 reinforce the overall structure of the blade.

The outer blade 6 is formed when sheet metal of a thickness of about 0.6 mm is punched by a die into the form of the outer cutting blade comprised of a polygonal hole, hub, ribs, spokes, serrated periphery, and teeth.

FIGS. 11-13 disclose the inner cutting blade 19. Like the outer cutting blade 6, the inner cutting blade 19 has a polygonal hole 20 formed in the center of it through which a rotary shaft can pass. The polygonal shape locks into the polygonally (hexagonally) shaped rotary shaft thereby securing the cutting blade such that it will not rotate around the rotary shaft.

The inner cutting blade 19 has the same number of teeth around the periphery as the outer cutting blade. In this preferred embodiment, three teeth are located 120 degrees apart around the circumference of the inner cutting blade. As mentioned above, for larger capacity shredders which require larger cutting blades with a greater circumference, four teeth can be placed 90 degrees apart around the periphery. For shredders with smaller capacities and thus smaller cutting blades, two teeth can be placed 180 degrees apart around the periphery.

The inner cutting blade tooth 21 is preferably shaped like a spear at its tip 22. It is formed by folding over the 0.6 mm metal sheet two times such that the approximate thickness of the tooth is 1.8 mm and then punched by a die into the form of the spear shaped tooth. The width of the inner cutting tooth 23 is therefore approximately three times greater than the width of the base 24 of the inner cutting blade 19.

As seen in FIGS. 14 and 15, the outer cutting blades 6 sandwich and flank the inner cutting blade 19 in a configuration such that the teeth are aligned. The ribs 10 and spokes 12 of the outer cutting blade 6 and the tooth indented portion 18 provide support and secure the inner cutting blade 19 to ensure proper alignment.

It should be appreciated that although this preferred embodiment discloses three blades coupled together to form a cutting blade assembly 5, the same mechanism can be accomplished with fewer (or more) than three blades. For example, rather than have three blades, one blade can have a base of sufficient width to support two narrow teeth flanking a larger spear shaped tooth. In addition, in certain situations, more than three adjacent teeth may be advantageous. In such situations, one or more blades can be used to support the adjacent teeth.

Accordingly, this patent discloses a rotary cutting assembly comprised of a plurality of cutting blades; said cutting blades having at least two sets of at least three adjacent teeth wherein said adjacent teeth flank each other; said sets of adjacent teeth spaced apart from other sets of adjacent teeth along the circumference of the cutting blade. The adjacent teeth may be comprised of at least one inner tooth flanked by at least two outer teeth, wherein said outer teeth may be narrower than said inner tooth.

The patent also illustrates a rotary cutting assembly comprised of a plurality of cutting blade assemblies having at least two sets of at least three adjacent teeth, wherein said adjacent teeth flank each other, said sets of adjacent teeth being spaced apart along the circumference of the cutting blade assembly. The adjacent teeth may be comprised of at least one inner tooth flanked by at least two outer teeth, wherein said outer teeth may be narrower than said inner tooth. The cutting blade assemblies may be comprised of at least two cutting blades flanking each other.

The patent further discloses a rotary cutting assembly comprised of at least one cutting blade having at least two sets of at least three adjacent teeth wherein said adjacent teeth flank each other; said sets of adjacent teeth being spaced apart along the circumference of the cutting blade. The adjacent teeth may be comprised of at least one inner tooth flanked by at least two outer teeth, wherein said outer teeth may be narrower than said inner tooth.

FIGS. 16-18 show a partially assembled rotary cutting assembly 1 with the cutting blade assemblies 5 spaced apart. The cutting blade assemblies in this preferred embodiment are spaced apart by the hubs 7 in outer cutting blades 6. The teeth 4 are displaced in the longitudinal direction to form a helix. If the teeth were all aligned, then a greater force would be required to punch through paper. By displacing the teeth, a lesser, constant force is required. Though a helix is described herein, any configuration may be used such that the teeth are not directly aligned. In addition, it may be possible to have varying numbers of teeth around the circumference of each cutting assembly, such that some cutting assemblies have two sets of teeth around its periphery and others have three or more sets.

FIGS. 19 and 20 show the interaction between two rotary cutting assemblies 25. As paper is fed between the two assemblies, it is shredded into rectangles. The width of the rectangle is determined by the space between the cutting blade assemblies created by the hubs. The length of the rectangle is determined by the distance between the teeth around the circumference of the cutting blade. Though the size can vary, an exemplar shredded piece of paper is 4 mm by 40 mm.

FIGS. 21-25 disclose another preferred embodiment of the present invention. In this embodiment the components are essentially the same as above, except that the cutting blade assembly does not have a hub protruding from it. Since there is no hub to create space between the cutting blade assemblies, a separate spacer 26 is used to separate the cutting blade assemblies. (See FIGS. 29 & 30.)

As seen in FIGS. 26-33, this preferred embodiment also discloses paper strippers 27 which are coupled to the spacers 26. Both the paper strippers 27 and the spacers 26 are commonly known to those skilled in the art. The paper strippers ensure that the papers shreds fall downward into the shredder base, and also prevent the paper from accumulating between the cutting blade assemblies. Though the paper strippers were not shown in the previous embodiment, a fully assembled shredder utilizing the rotary cutting assembly above would preferably have the paper strippers coupled to the hubs between the cutting blade assemblies.

Other preferred embodiments are also possible. For example, the principle of three or more adjacent teeth can also be applied to Diamond Cut shredders.

FIGS. 34-48 disclose another preferred embodiment in which a cutting blade assembly is comprised of an inner cutting blade which is supported on both sides by supporting discs. Spacers are then used to separate the cutting blade assemblies along a rotary cutting assembly.

FIGS. 39 through 42 show one of the supporting discs 30 which is punched from sheet metal having a thickness of 0.3 mm. This reinforced supporting disc 30 has a hub 7 and indentations or spokes 34 which provide reinforcement. The hub 7 has a polygonal hole 8 formed in the center of the hub 7 through which a rotary shaft can pass. As in prior embodiments the periphery of the supporting disc may be serrated to help pull paper to be cut through the rotary cutting assemblies.

The reinforced supporting disc 30 has supporting teeth 33 which provide support for the cutting blade teeth 31. As seen in FIG. 34, the cutting blade tooth 31 is supported from behind by the supporting tooth 33 of the reinforced supporting disc 30. In this embodiment the reinforcing teeth 33 are located 120 degrees apart around the circumference of the cutting blade, although the number and spacing of the teeth may vary as detailed above. The reinforced supporting disc 30 also has three holes 35 to which the cutting disc can be secured.

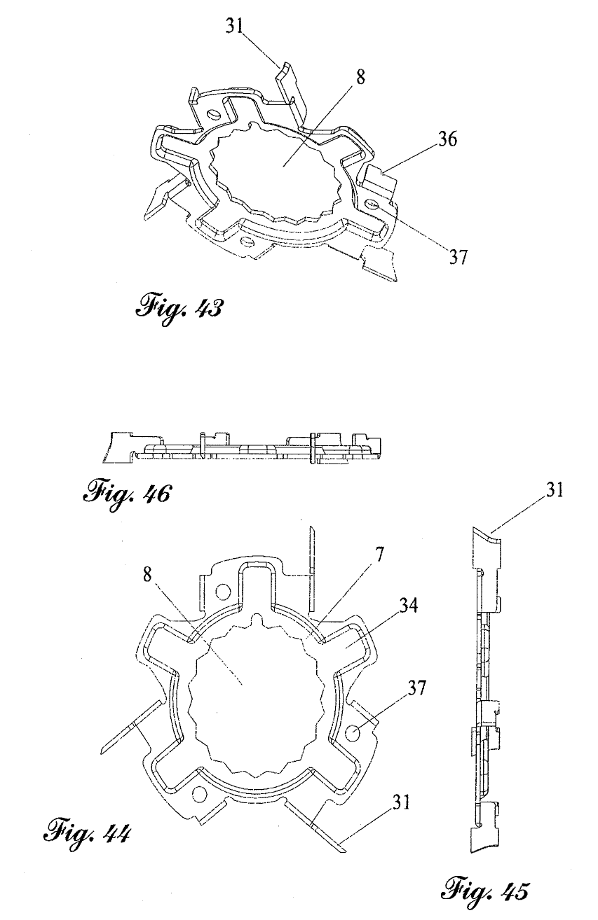

FIGS. 43-46 disclose an embodiment where the cutting disc has a hub 7 and spokes 34 for reinforcement. The hub 7 has a polygonal hole 8 formed in the center of the hub 7 through which a rotary shaft can pass.

In this preferred embodiment, the cutting blade is punched from sheet metal having a thickness of 0.3 mm. The cutting blade has three cutting teeth 31 which are tapered in order to facilitate paper shredding. The cutting blade has three appendages 36 which secure it to the three holes 35 in the reinforced supporting disc 30. The cutting blade also has three holes 37 to which the non-reinforced supporting disc 29 can be secured.

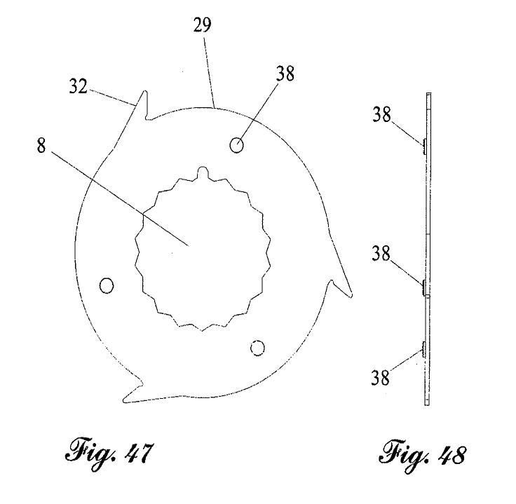

FIGS. 47 and 48 disclose a non-reinforced supporting disc which is punched from sheet metal having a thickness of 0.3 mm. The non-reinforced supporting disc has three appendages 38 which attach to the three holes 37 in the cutting blade. The non-reinforced supporting disc, likewise, has the same number of reinforcing teeth 32 as cutting teeth on the cutting blade, and provides support from behind, as seen in FIG. 34.

It should be appreciated that although this preferred embodiment discloses a cutting blade with three cutting teeth and the corresponding three supporting teeth on each supporting disc, any number of teeth and corresponding supporting teeth may be used. Likewise, although three holes were disclosed on both the cutting disc and the reinforced supporting disc, along with corresponding appendages to attach to said holes, other embodiments include configurations with at least one appendage interacting with at least one hole.

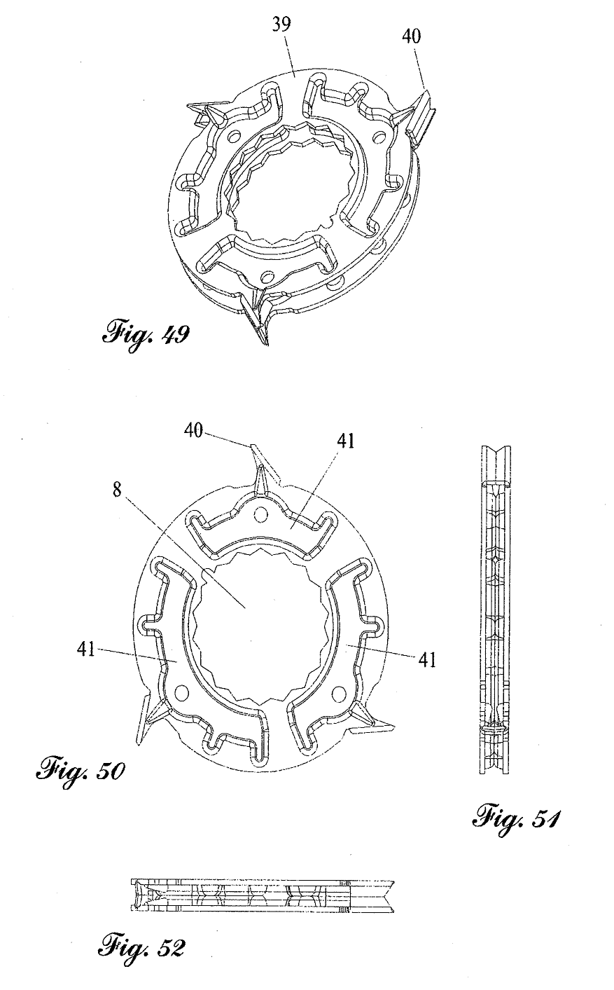

FIGS. 49 through 60 disclose another preferred embodiment in which a cutting blade assembly is comprised of two cutting blades punched from sheet metal having a thickness of about 0.3 mm. Spacers are then used to separate the cutting blade assemblies along a rotary cutting assembly.

In this preferred embodiment, the cutting blades 39 have three tapered teeth 40 with three indentations or ribs which 41 provide stability and support. The ribs are crown shaped in order to provide added stability. A polygonal hole 8 is formed in the center of the cutting blades 39 through which a rotary shaft can pass.

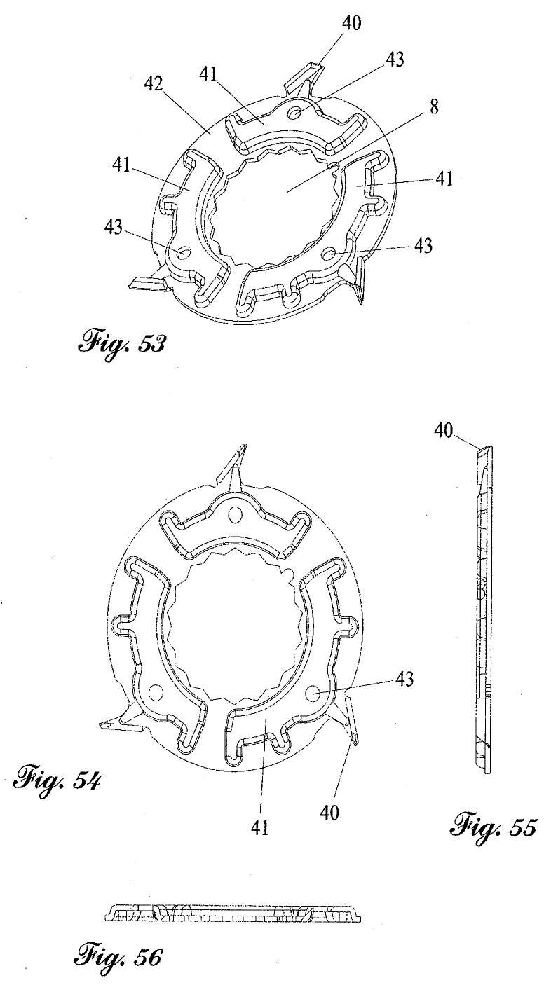

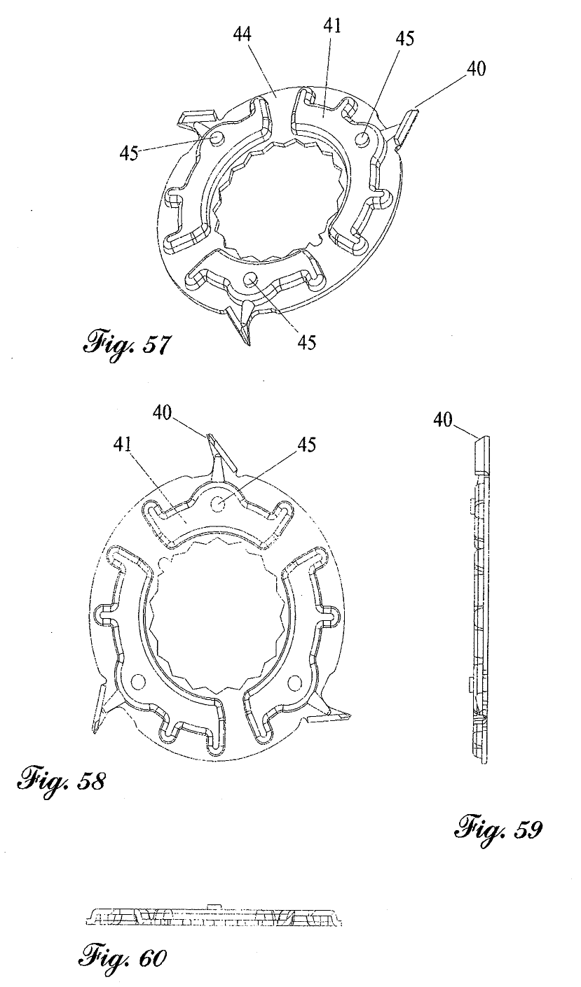

As seen in FIGS. 53-56 one of the cutting blades 42 has a hole 43 in each of the ribs. As seen in FIGS. 57-60, the other cutting blade 44 has an appendage 45 which attach to the hole 43. Although this preferred embodiment discloses cutting blades with three teeth and three ribs with an appendage or hole in each of the ribs, the number of teeth, ribs, appendages, and holes may vary, so long as the cutting blades each having at least one rib, and the rib in one cutting blade has at least one hole, while the rib in the other cutting blade has at least one appendage to fit into the hole.

The following claims are thus to be understood to include what is specifically illustrated and described above, what is conceptually equivalent, what can be obviously substituted and also what essentially incorporates the essential idea of the invention. Those skilled in the art will appreciate that various adaptations and modifications of the just-described preferred embodiment can be configured without departing from the scope of the invention. The illustrated embodiment has been set forth only for the purposes of example and that should not be taken as limiting the invention. Therefore, it is to be understood that, within the scope of the appended claims, the invention may be practiced other than as specifically described herein.

I claim:

1. A cutting blade assembly for a paper shredder comprising: an inner cutting blade; and two supporting discs, one supporting disc disposed on each side of the inner cutting blade.

2. The cutting blade assembly of claim 1 wherein the inner cutting blade has at least one indentation for reinforcement.

3. The cutting blade assembly of claim 1 wherein at least one of the supporting discs has at least one indentation for reinforcement.

4. The cutting blade assembly of claim 2 wherein at least one of the supporting discs has at least one indentation for reinforcement.

5. The cutting blade assembly of claim 1 wherein at least one of the supporting discs has an appendage which secures to the inner cutting blade.

6. The cutting blade assembly of claim 2 wherein at least one of the supporting discs has an appendage which secures to the inner cutting blade.

7. The cutting blade assembly of claim 3 wherein at least one of the supporting discs has an appendage which secures to the inner cutting blade.

8. The cutting blade assembly of claim 4 wherein at least one of the supporting discs has an appendage which secures to the inner cutting blade.

9. The cutting blade assembly of claim 1 wherein at least one of the supporting discs has a hole to which the inner cutting blade secures.

10. The cutting blade assembly of claim 2 wherein at least one of the supporting discs has a hole to which the inner cutting blade secures.

11. The cutting blade assembly of claim 3 wherein at least one of the supporting discs has a hole to which the inner cutting blade secures.

12. The cutting blade assembly of claim 4 wherein at least one of the supporting discs has a hole to which the inner cutting blade secures.

13. A cutting blade assembly for a paper shredder comprising: two cutting blades; the cutting blades each having at least one rib; the rib in one cutting blade having at least one hole into which an appendage on the rib of the other cutting blade is secured.
